(19) United States
(12) Patent Application Publication
(10) Pub. No.: US 2015/0257410 A1
(43) Pub. Date: Sep. 17, 2015

(54) Ice Cream Maker with Collapsible Bucket

(71) Applicant: Hamilton Beach Brands, Inc., Glen Allen, VA (US)

(72) Inventors: Verena Baragiola, Richmond, VA (US); Yvonne Olson, Richmond, VA (US); Ernest B Pryor, JR., Maidens, VA (US); Michael Allen, Glen Allen, VA (US); Mark C Steiner, Midlothian, VA (US); Michael Garman, Moseley, VA (US)

(21) Appl. No.: 14/657,182

(22) Filed: Mar. 13, 2015

Related U.S. Application Data
(60) Provisional application No. 61/953,022, filed on Mar. 14, 2014.

(51) Int. Cl. A23G 9/12

(52) U.S. Cl. CPC A23G 9/12

(57) ABSTRACT

An ice cream maker comprises a collapsible outer bucket having a closed bottom end and an open top end, a mixing assembly selectively insertable into the outer bucket, a handle having first and second ends directly or indirectly affixed to the outer bucket. The handle is selectively supported by the mixing assembly such that the top end of the outer bucket is indirectly supported by the mixing assembly.

### CROSS-REFERENCE TO RELATED APPLICATIONS

This application claims priority to U.S. Provisional Application Ser. No. 61/953,022, filed Mar. 14, 2014, the contents of which are incorporated herein by reference in its entirety.

### BACKGROUND OF THE DISCLOSURE

The present disclosure relates generally to ice cream makers.

A home ice cream maker is a machine used to make small quantities of ice cream for personal consumption. One type of home ice cream maker comprises an outer bucket (which may also be termed an ice bucket), a smaller inner bucket placed within the outer bucket, and a rotating paddle to stir ingredients in the inner bucket. The paddle may be rotated via a hand crank or an electric motor. The outer bucket is typically filled with a mixture of salt and ice, which is used to freeze an ingredient mixture in the inner bucket into a frozen treat.

The outer bucket of conventional home ice cream makers is fairly large, as it must accommodate the inner bucket and a sufficient quantity of ice to freeze the ingredient mixture. The outer bucket is constructed of a rigid material such as wood, plastic, or metal. Because the outer bucket is typically the largest component of a conventional home ice cream maker, the large size and rigid material of the outer bucket means that such an ice cream maker takes up a large amount of space when shipped, when stocked on a store shelf, and when stored (either in a warehouse or by a user). This large amount of space increases shipping and storage costs and makes the conventional home ice cream maker less desirable to users who may have limited storage space for such an appliance.

It has heretofore not been discovered how to create a home ice cream maker that has a sufficiently large outer bucket to enable the home ice cream maker to function properly while having reduced size when not in use for shipping and storage. The home ice cream maker of the following disclosure accomplishes the above and other objectives and overcomes at least the above-described or other disadvantages of conventional home ice cream makers.

### BRIEF SUMMARY OF THE DISCLOSURE

An ice cream maker is disclosed herein. In one embodiment of the subject appliance, the ice cream maker comprises a collapsible outer bucket having a closed bottom end and an open top end, a mixing assembly selectively insertable into the outer bucket, a handle having first and second ends directly or indirectly affixed to the outer bucket. The handle is selectively supported by the mixing assembly such that the top end of the outer bucket is indirectly supported by the mixing assembly.

The outer bucket may comprise fabric. The fabric may be waterproof.

The outer bucket may be generally cylindrical.

The mixing assembly may comprise an inner bucket, a lid, a paddle, and a motor. The lid is selectively mountable to the inner bucket and defines a shaft opening. The paddle is selectively insertable into the inner bucket and has a shaft that is selectively insertable through the shaft opening. The motor is selectively mountable on the lid. The motor is selectively matable to the shaft of the paddle to selectively rotate the paddle within the inner bucket.

The ice cream maker may further comprise a motor housing containing the motor and having at least one elongated groove defined in a top surface thereof. The handle may engage with the groove when the handle is selectively supported by the mixing assembly.

The ice cream maker may further comprise a bottom plate selectively insertable into the outer bucket such that the bottom plate sits on the bottom end of the outer bucket. A concavity or a convexity may be defined on a top surface of the bottom plate, and a corresponding convexity or concavity may be defined on a bottom surface of the inner bucket. The concavity or convexity of the bottom plate may engage with the corresponding convexity or concavity of the inner bucket when the mixing assembly is selectively inserted into the outer bucket.

The ice cream maker may further comprise a ring assembly selectively matable to a top edge of the outer bucket. The first and second ends of the handle may be indirectly affixed to the outer bucket via the ring assembly.

The ring assembly may further comprise at least one male portion and at least one female portion. The at least one male portion and the at least one female portion may be selectively matable. At least a portion of the top end of the outer bucket may be entrapped between the at least one male portion and the at least one female portion when the at least one male portion and the at least one female portion are selectively mated.

The at least one male portion may comprise first and second semi-circular male portions. The at least one female portion may comprise first and second semi-circular female portions. The first semi-circular male and female portions may be selectively matable. The second semi-circular male and female portions may be selectively matable. The mated first semi-circular male and female portions may be selectively matable to the mated second semi-circular male and female portions, such that the ring assembly comprises a complete circle.

First and second opposing gaps may be defined in the top end of the outer bucket. When the ring assembly is selectively mated to the top edge of the outer bucket, (i) a first mating location of the mated first semi-circular male and female portions and the mated second semi-circular male and female portions may be aligned with the first gap and (ii) a second mating location of the mated first semi-circular male and female portions and the mated second semi-circular male and female portions may be aligned with the second gap.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of an ice cream maker, according to one embodiment of the present disclosure;

FIG. 2 is a perspective view of the separated components of the ice cream maker of FIG. 1;

FIG. 3 is a perspective view of the outer bucket of the ice cream maker of FIG. 1;

FIG. 4 is a perspective view of the base of the ice cream maker of FIG. 1;

FIG. 5 is a cross-sectional view of the ice cream maker of FIG. 1;

FIG. 6 is a top perspective view of one upper half-ring and one lower half-ring of the ice cream maker of FIG. 1;

FIG. 7 is a bottom perspective view of one upper half-ring of the ice cream maker of FIG. 1;

FIG. 8 is a close-up cross-sectional view of the mating of the outer bucket, an upper half-ring, and a lower half-ring of the ice cream maker of FIG. 1; and

FIG. 9 is a close-up perspective view of the mating portions of two upper half-rings and the handle of the ice cream maker of FIG. 1.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

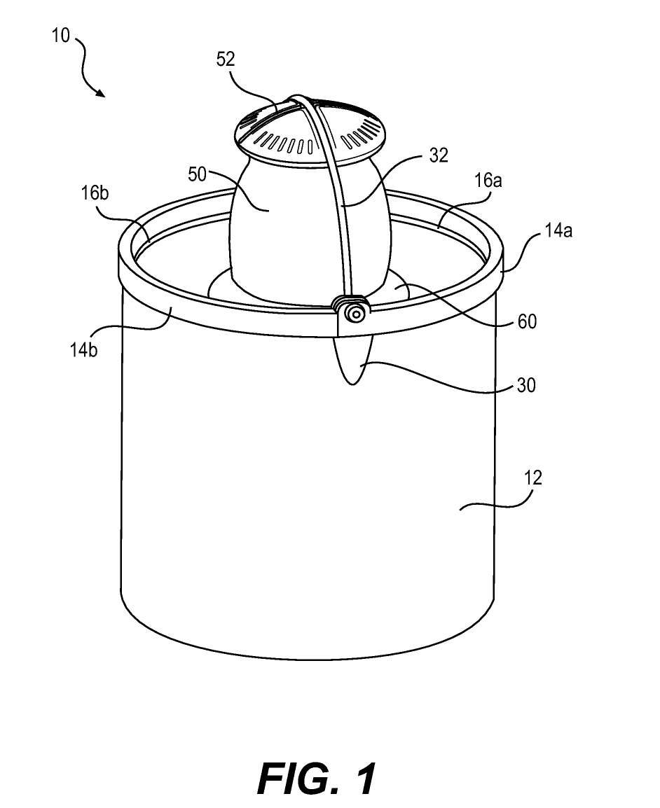

Referring to the drawings in detail, wherein like numerals indicate like elements throughout, FIGS. 1-9 illustrate an ice cream maker 10 in accordance with a preferred embodiment of the present disclosure. Ice cream maker 10 may be, for example, a four quart ice cream maker (the capacity is based on the size of the inner bucket, but the size of the inner bucket also affects the size of the outer bucket).

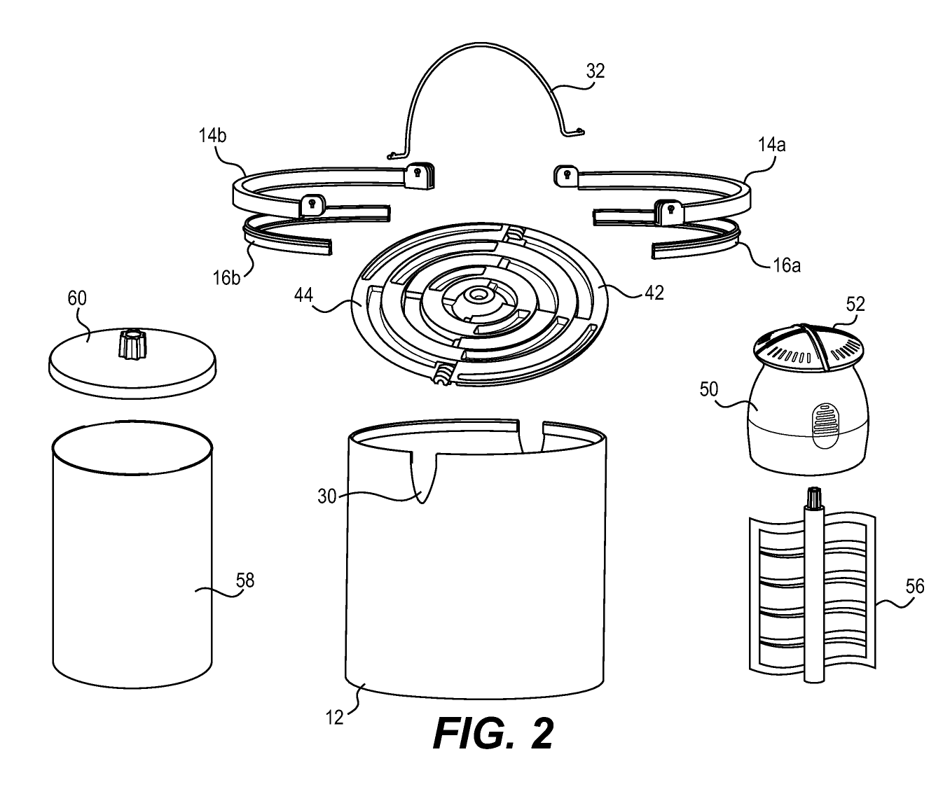

As seen in FIGS. 1 and 2, ice cream maker 10 comprises collapsible outer bucket 12, inner bucket 58 and corresponding lid 60, a foldable bottom plate comprising a first bottom plate half 42 and second bottom plate half 44, a first upper half-ring 14a, a second upper half-ring 14b, a first lower half-ring 16a, a second lower half-ring 16b, a handle 32, a motor housing 50, and a rotating paddle 56.

Advantageously, outer bucket 12 of ice cream maker 10 is constructed of fabric such that outer bucket 12 is collapsible and may be folded for transport and storage and unfolded for assembly and use. Outer bucket 12 is constructed of waterproof cloth or fabric. Outer bucket 12 may be constructed of any suitable fabric that is sufficiently flexible to allow outer bucket 12 to be readily folded and unfolded and sufficiently waterproof to keep water from melting ice contained within outer bucket 12 during use of ice cream maker 10. For example, outer bucket 12 may comprise any suitable natural or synthetic fabric that is laminated to or coated with a waterproofing material such as rubber, polyvinyl chloride (PVC), polyurethane (PU), silicone elastomer, fluoropolymers, or wax. In one embodiment of the present disclosure, outer bucket 12 is constructed of synthetic woven fiber cloth (such as polyester, nylon, etc.) that has a PVC coating on the inside surface. In this embodiment, the cloth is stitched together with synthetic thread and the seams are sealed with a clear PVC tape material covering the length of the seam from the inside.

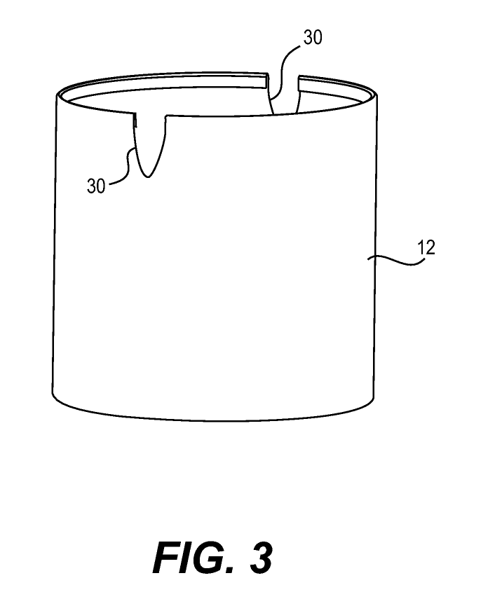

When unfolded for assembly, outer bucket 12 has a generally cylindrical shape with an open top end. As seen in FIG. 3, the top edge of outer bucket 12 may be folded upon itself toward the interior for assembly (described further below). Gaps 30 are defined in opposing sides of outer bucket 12 at the top edge. Opposing gaps 30 provide discontinuities in the top edge to allow the half-rings to mate (described further below), as well as providing an overflow to allow water from melting ice to escape outer bucket 12 without leaking into inner bucket 58 or motor housing 50.

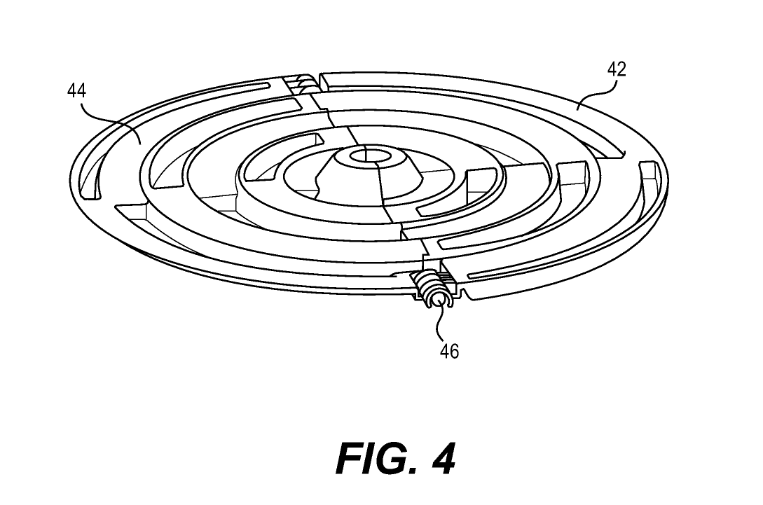

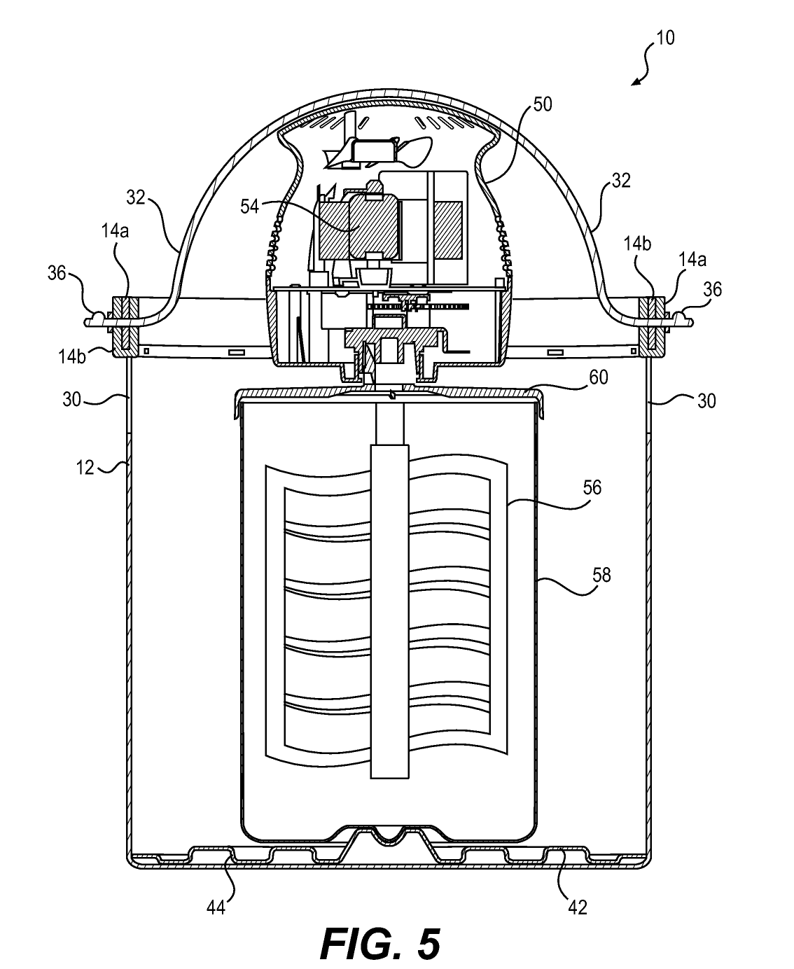

As seen in FIG. 4, the bottom plate is foldable and comprises first bottom plate half 42 and second bottom plate half 44 selectively joined at hinge 46. First bottom plate half 42 and second bottom plate half 44 may be separated during transport and storage or may be joined at hinge 46 but folded together. When ice cream maker 10 is to be assembled for use, first bottom plate half 42 and second bottom plate half 44 are joined at hinge 46 (if not already) and unfolded into the flat position seen in FIG. 4. The joined first bottom plate half 42 and second bottom plate half 44 may then be placed into the bottom of outer bucket 12 such that first bottom plate half 42 and second bottom plate half 44 rest against the bottom of outer bucket 12, as seen in FIG. 5.

The ring assembly (which comprises first upper half-ring 14a, second upper half-ring 14b, first lower half-ring 16a, and second lower half-ring 16b) is affixed to the top edge of outer bucket 12, as described in detail below. Handle 32 is affixed to the ring assembly, as described in detail below. Paddle 56 is assembled together with lid 60 such that the top of the center shaft of paddle 56 projects through the hole defined in the center of lid 60. The assembled combination of paddle 56 and lid 60 is assembled together with motor housing 50 such that the top of the center shaft of paddle 56 projects through a hole defined in the bottom of motor housing 50. Within motor housing 50, the top of the center shaft of paddle 56 indirectly connects to motor 54 via a conventional clutch/gearing arrangement. The assembled combination of paddle 56, lid 60, and motor housing 50 is assembled together with inner bucket 58 such that paddle 56 is inserted into the interior of inner bucket 58 and lid 60 seals the top opening of inner bucket 58. The assembled combination of paddle 56, lid 60, motor housing 50, and inner bucket 58 are placed into the interior of outer bucket 12, with the bottom of inner bucket 58 resting on the bottom plate, as seen in FIG. 5. A concavity in the center of the bottom of inner bucket 58 receives a corresponding convexity in the center of the bottom plate (as seen in FIG. 5) to help retain inner bucket 58 in position centered within outer bucket 12.

Paddle 56, lid 60, motor housing 50, inner bucket 58, and outer bucket 12 need not be assembled in the order described above. There are several different ways/orders in which these components may be assembled to arrive at the configuration seen in FIG. 5. As just one example, inner bucket 58 may be placed into outer bucket 12, the assembled combination of paddle 56 and lid 60 may then be assembled with inner bucket 58, and motor housing 50 may then be placed onto the top of the center shaft of paddle 56 that projects through the hole defined in the center of lid 60. In any event, the necessary ingredients to make ice cream must be placed into inner bucket 58 prior to placing lid 60 on inner bucket 58.

One or more grooves 52 (seen in FIG. 2) may be defined in the top surface of motor housing 50. If two grooves are so defined, the two grooves may be perpendicular to each other, as seen in FIG. 5. After the assembled combination of paddle 56, lid 60, motor housing 50, and inner bucket 58 are placed into outer bucket 12, as seen in FIG. 5, handle 32 (which may be termed a bucket handle or a bale handle) is rotated up and over the top of motor housing 50 until handle 32 engages with one of grooves 52 on the top of motor housing 50. With handle 32 engaged with one of grooves 52 on top of motor housing 50, a semi-rigid structure is created in that handle 32 retains the assembled combination of paddle 56, lid 60, motor housing 50, and inner bucket 58 firmly against the bottom plate while holding up the ring assembly such that outer bucket 12 retains its assembled, cylindrical shape. During operation of ice cream maker 10, the rotation of paddle 56 within inner bucket 58 and the interaction between the rotating paddle and the ice cream ingredients in inner bucket 58 would tend to cause motor housing 50 and electric motor 54 (described below) to rotate in the opposite direction of paddle 56, especially as the ingredients thicken. Such rotation of housing 50 and electric motor 54 is undesirable. Conventional home ice cream makers typically comprise two opposing support arms that are integral with and extend radially out from the motor housing. The distal ends of the support arms of conventional home ice cream makers contact and engage with the top rim of the rigid outer bucket to partly support the motor housing and electric motor and to resist rotation of the motor housing and electric motor during operation. Advantageously, in embodiments of the present disclosure, the engagement of handle 32 with one of grooves 52 resists the tendency of motor housing 50 and electric motor 54 to rotate, thereby eliminating the necessity for additional support arms. Conventional home ice cream makers typically comprise a bucket handle or bale handle rotatably affixed to the rigid outer bucket. However, such a handle of conventional home ice cream makers does not contact or engage with the motor housing and does nothing to resist rotation of the motor housing and motor.

Motor housing 50 contains electric motor 54 which receives electric power via a power cord (not illustrated) plugged into an electrical outlet and controlled via a power switch (not illustrated). When ice cream maker 10 has been fully assembled and electric motor 54 is energized, electric motor 54 rotates paddle 56 within inner bucket 58. A user operates electric motor 54 for a desired amount of time to mix ingredients within inner bucket 58 to make ice cream.

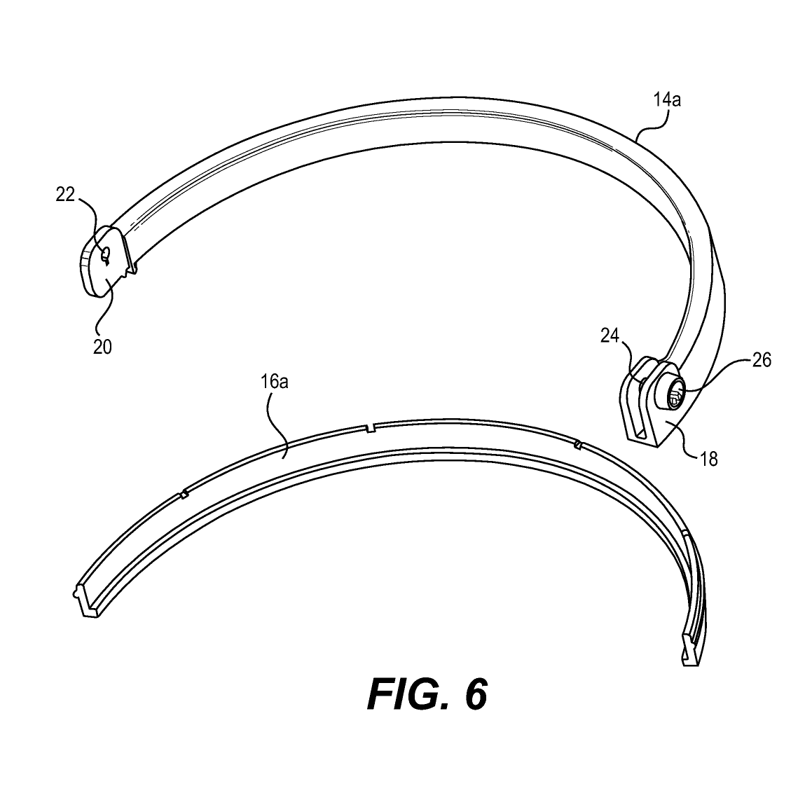

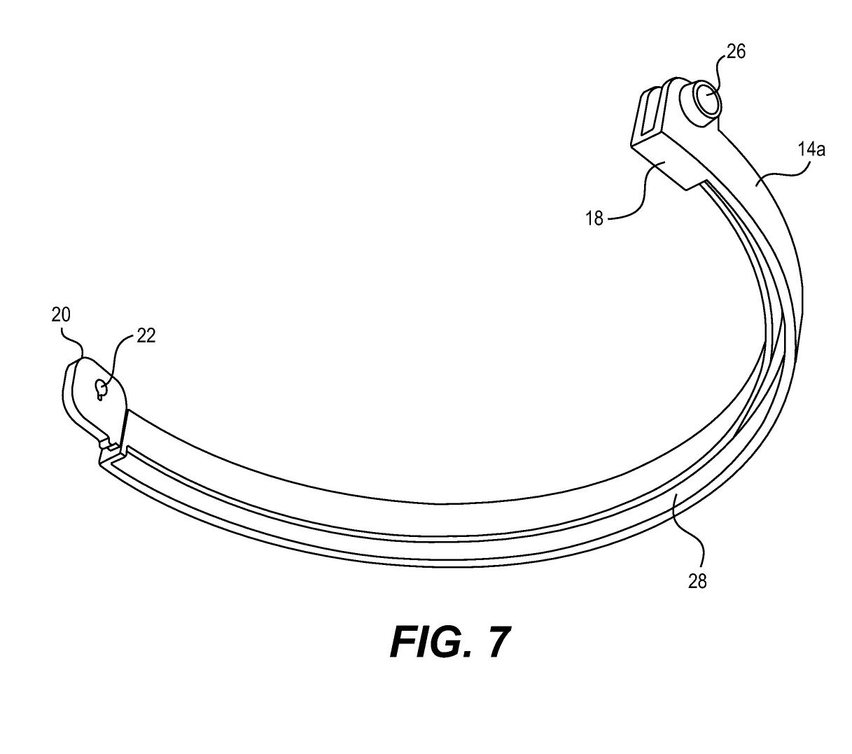

Referring now to FIG. 6, first upper half-ring 14a and first lower half-ring 16a are illustrated. Second upper half-ring 14b is identical to first upper half-ring 14a. Second lower half-ring 16b is identical to first lower half-ring 16a. FIG. 7 illustrates the underside of first upper half-ring 14a. The first and second upper half-rings each comprise a female end 18, a male end 20, a keyed hole 22 in male end 20, a keyed hole 24 in the inner wall of female end 18, a ribbed hole 26 in the outer wall of female end 18, and a channel 28 (seen in FIG. 7) on the underside. The channel 28 on the underside of each half-ring receives a corresponding lower half-ring and a corresponding portion of the folded top edge of outer bucket 12 when the ring assembly and outer bucket 12 are assembled.

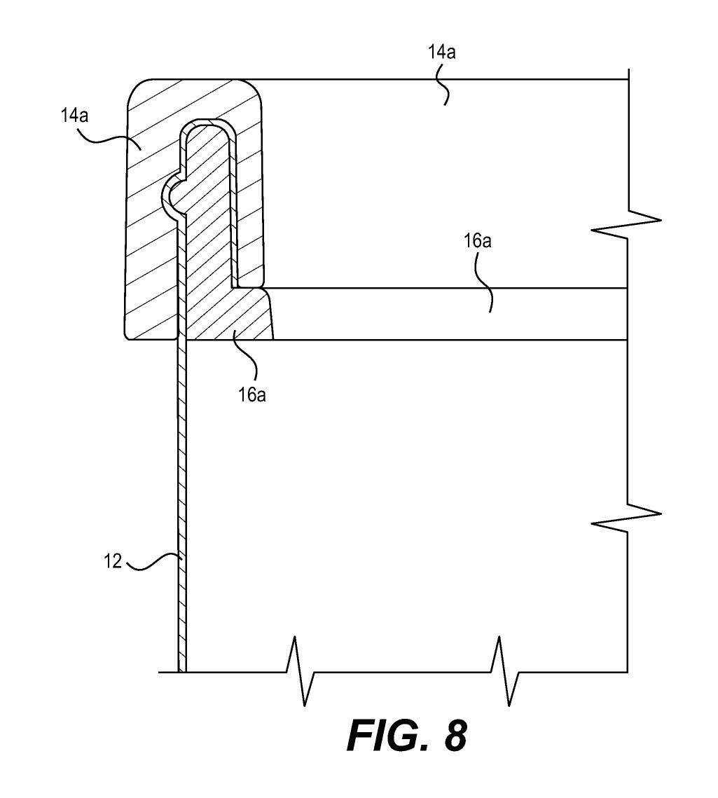

To assemble the ring assembly (which comprises the first and second upper half-rings and the first and second lower half-rings) and outer bucket 12, the top edge of outer bucket 12 is folded down onto itself toward the interior, as seen in FIG. 3. Each lower half-ring is separately inserted up into a portion of the folded top edge of outer bucket 12, taking care that each lower half-ring is approximately centered between gaps 30 (with each lower half-ring being on an opposite side of outer bucket 12). The vertical portion of each lower half-ring, along with its corresponding portion of the folded top edge of outer bucket 12, is inserted into channel 28 of a different upper half-ring until each lower half-ring snaps securely into position within its corresponding upper half-ring. When each lower half-ring is inserted into its corresponding upper half-ring, a ridge (seen in FIGS. 6 and 8) running the entire length of each lower half-ring engages with a corresponding depression (seen in FIG. 8) within channel 28 of each upper half-ring. This mating arrangement of upper half-ring, lower half-ring and top edge of outer bucket is illustrated in the sectional view of FIG. 8. FIG. 8 illustrates the mating arrangement of first upper half-ring 14a and first lower half-ring 16a with outer bucket 12, but the mating arrangement of second upper half-ring 14b and second lower half-ring 16b with outer bucket 12 is identical.

As seen in FIG. 7, channel 28 does not run the entire length of the upper half-ring so that the channel (and the corresponding lower half-ring) does not interfere with the mating of the male and female ends of the two upper half-rings.

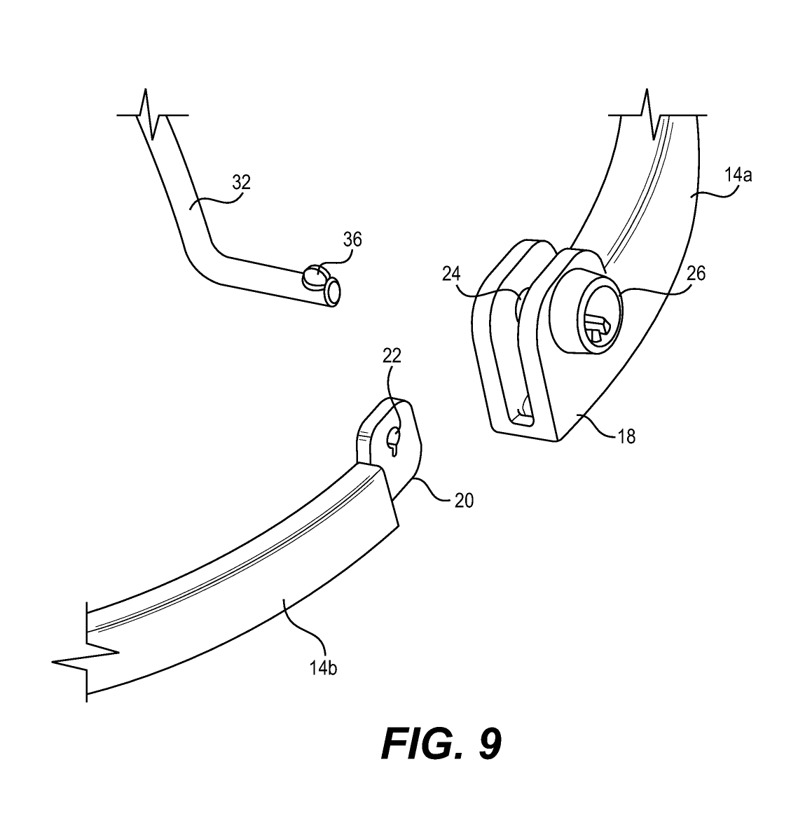

The male and female ends of the two upper half-rings are mated (this step may be performed before or after the lower half-rings and corresponding portions of the top edge of outer bucket 12 are inserted into channel 28 of the upper half-rings) by inserting male end 20 of first upper half-ring 14a into female end 18 of second upper half-ring 14b and inserting male end 20 of second upper half-ring 14b into female end 18 of first upper half-ring 14a. Keyed hole 22 of male end 20 of first upper half-ring 14a should be aligned with keyed hole 24 and ribbed hole 26 of female end 18 of second upper half-ring 14b. Similarly, keyed hole 22 of male end 20 of second upper half-ring 14b should be aligned with keyed hole 24 and ribbed hole 26 of female end 18 of first upper half-ring 14a. The alignment of these holes enables each end of handle 32 to be inserted into corresponding mated male/female ends of the upper half-rings. Each end of handle 32 comprises a nib 36 projecting from each end of handle 32. Nibs 36 engage with the key of hole 22 and hole 24 and the ribs of hole 26 such that the ends of handle 32 must be in a specific orientation (upside-down) relative to the upper half-rings for the ends of handle 32 to be inserted into or removed from corresponding mated male/female ends of the upper half-rings. (In FIG. 9, handle 32 is shown in an upright orientation to enable the detail of nib 36 to be seen. However, for insertion and removal, handle 32 needs to be flipped 180 degrees into an upside-down orientation.)

The novel structure and components of the ice cream of embodiments of the present disclosure provide an ice cream maker that functions conventionally when assembled but has a reduced size for transportation and storage when not assembled. Ice cream maker 10 may be packaged for transportation and storage as follows: motor housing 50 placed in inner bucket 58 and both placed into a shipping/storage package; upper half-rings 14a, 14b, lower half-rings 16a, 16b, and handle 32 separated and positioned together alongside inner bucket 58 within the shipping/storage package; outer bucket 12 separated, folded, and positioned alongside inner bucket 58 within the shipping/storage package; bottom plate halves 42, 44 either folded or separated and positioned together alongside inner bucket 58 within the shipping/storage package; and paddle 56 positioned alongside inner bucket 58 within the shipping/storage package.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure.

That which is claimed:

1. An ice cream maker comprising:
a collapsible outer bucket having a closed bottom end and an open top end;
a mixing assembly selectively insertable into the outer bucket; and
a handle having first and second ends directly or indirectly affixed to the outer bucket, the handle being selectively supported by the mixing assembly such that the top end of the outer bucket is indirectly supported by the mixing assembly.

2. The ice cream maker of claim 1, wherein the outer bucket comprises fabric.

3. The ice cream maker of claim 2, wherein the fabric is waterproof

4. The ice cream maker of claim 1, wherein the outer bucket is generally cylindrical.

5. The ice cream maker of claim 1, wherein the mixing assembly comprises:
an inner bucket;
a lid selectively mountable to the inner bucket, the lid defining a shaft opening;
a paddle selectively insertable into the inner bucket and having a shaft that is selectively insertable through the shaft opening; and
a motor selectively mountable on the lid, the motor selectively matable to the shaft of the paddle to selectively rotate the paddle within the inner bucket.

6. The ice cream maker of claim 5, further comprising a motor housing containing the motor and having at least one elongated groove defined in a top surface thereof;
wherein the handle engages with the groove when the handle is selectively supported by the mixing assembly.

7. The ice cream maker of claim 5, further comprising:
a bottom plate selectively insertable into the outer bucket such that the bottom plate sits on the bottom end of the outer bucket;
wherein a concavity or a convexity is defined on a top surface of the bottom plate;
wherein a corresponding convexity or concavity is defined on a bottom surface of the inner bucket; and
wherein the concavity or convexity of the bottom plate engages with the corresponding convexity or concavity of the inner bucket when the mixing assembly is selectively inserted into the outer bucket.

8. The ice cream maker of claim 1, further comprising:
a ring assembly selectively matable to a top edge of the outer bucket;
wherein the first and second ends of the handle are indirectly affixed to the outer bucket via the ring assembly.

9. The ice cream maker of claim 8, wherein the ring assembly comprises:
at least one male portion; and
at least one female portion;
wherein the at least one male portion and the at least one female portion are selectively matable; and
wherein at least a portion of the top end of the outer bucket is entrapped between the at least one male portion and the at least one female portion when the at least one male portion and the at least one female portion are selectively mated.

10. The ice cream maker of claim 9, wherein the at least one male portion comprises first and second semi-circular male portions;
wherein the at least one female portion comprises first and second semi-circular female portions;
wherein the first semi-circular male and female portions are selectively matable;
wherein the second semi-circular male and female portions are selectively matable;
wherein the mated first semi-circular male and female portions are selectively matable to the mated second semi-circular male and female portions, such that the ring assembly comprises a complete circle.

11. The ice cream maker of claim 10, wherein first and second opposing gaps are defined in the top end of the outer bucket; and
wherein, when the ring assembly is selectively mated to the top edge of the outer bucket, (i) a first mating location of the mated first semi-circular male and female portions and the mated second semi-circular male and female portions is aligned with the first gap and (ii) a second mating location of the mated first semi-circular male and female portions and the mated second semi-circular male and female portions is aligned with the second gap.
